(19) United States
(12) Patent Application Publication
(10) Pub. No.: US 2006/0200333 A1
(43) Pub. Date: Sep. 7, 2006

(54) Optimizing active decision making using simulated decision making

(76) Inventors: Mukesh Dalal, Davis, CA (US); Armand Prieditis, Davis, CA (US)

Correspondence Address: Mukesh Dalal, 1533 Rio Grande Street, Davis, CA, 95616, US

(21) Appl. No.: 10/552,645

(22) PCT Filed: Apr. 5, 2004
(86) PCT No.: PCT/IB04/50401

§ 371 Date: Oct. 7, 2005

Related U.S. Application Data
(60) Provisional application No. 60/462,210, filed on Apr. 10, 2003.

(51) Int. Cl. G06F 17/50; G06F 15/00; H04J 1/16; H04J 15/00

(52) U.S. Cl. 703/17; 712/43; 370/546; 370/252

(57) ABSTRACT

A method and a computer implemented system for improving an active decision making process by using a simulation model of the decision making process. The simulation model is used to evaluate the impact of alternative decisions at a choice point, in order to select one alternative. The method or system may be integrated with an external system, like a manufacturing execution system. The simulation model may be stochastic, may be updated from monitoring the external system or the simulations, or may contain a Bayesian network

### TECHNICAL FIELD

This invention relates in general to the field of decision making, and more particularly, to the integration of simulated and active decision making.

### BACKGROUND ART

Decision making requires choosing among several alternatives. For a decision-making agent, this might involve selecting a specific action from several alternative actions that are possible at any given point of time. Active decision making involves repeating this selection of an appropriate action in real-time at subsequent points of time.

According to decision-theory, we should always make the decision that maximizes our future utility, where utility is some measure such as profit or loss, pain or pleasure, or time. To make a real-time decision, we need to elaborate possible future decision sequences and choose that immediate decision that results in the highest utility. For example, in chess, we might be considering five possible moves and for each of those five moves, we might have to consider five responses from our opponent, and for each of those five responses we might have to consider five responses from us . . . and so on, until we reach the end of the game, where the outcome is either a win, loss, or draw. If one of those moves is guaranteed to lead to a winning outcome, then that move is the move of choice.

FIG. 1 shows a portion of the lookahead tree built with this strategy. Nodes in this tree represent states or situations of the chessboard; directed arcs represent moves that result in a new state. The arcs emanating from the root node represent the first player's move possibilities; the ones from the level below that, the second player's move possibilities; alternate layers represent the alternating moves between the two players. If moving the queen is guaranteed to lead to a winning outcome and the rest of the moves are not, then that is the move of choice.

In general, it is not feasible to compute the actual outcome for a given position (except for those near the end) in real time because the full lookahead tree is too large to search. As a result, most chess programs look ahead to a limited horizon, and at this horizon they return a heuristic estimate of the final outcome. A positive heuristic estimate might signify a desirable state; a negative outcome, an undesirable state; and a zero outcome, a neutral state. In particular, IBM's Deep Blue program used a weighted combination of material, position, king's safety and tempo for its heuristic function. For example, the material portion might score each pawn 1, each bishop 3, each knight 4, each rook 5, and the queen 9. Using such a lookahead, Deep Blue managed to defeat Gary Kasparov, the world champion human chess player.

Branch-and-bound pruning is a typical approach to further restrict the lookahead tree. It allows pruning a path to a state if it can be proved that that outcome at that state will not affect the value of an ancestor. For example, FIG. 2 shows a lookahead tree where the object is to compute the minimum value over the tree. If the heuristic is guaranteed to be a lower-bound of the final backed-up value, then we can use that property to prune an entire subtree, thus increasing the efficiency of lookahead. The figure shows that, after visiting the left subtree, the root's value with be less than or equal to three; if the heuristic underestimate at the left subtree is five, then that entire subtree can be pruned according to the branch-and-bound principle.

FIG. 3 shows why branch-and-bound fails when uncertainty is present In this FIG., bundled arcs represent uncertainty. For example, the root's right child is a single decision that has two possible outcomes, one with probability 0.2 and the other with probability 0.8. This might represent a machine producing a faulty part with probability 0.2 and a non-faulty one with probability 0.8. The final backed-up value at this probabilistic child is the weighted sum of the two sibling outcomes, where the weighting is according to the probabilities. Given that the current pruning bound at the root is 3 (derived from the left child), the pruning bound at the child with the 0.2 arc becomes 3/0.2=15, which is an increase in the pruning bound of the parent Since this increase will happen at any node with uncertainty below it, the pruning bound grows exponentially large and therefore becomes useless for pruning. This means that little or no pruning is possible when uncertainty is involved. As a result, is not feasible to produce deep lookahead trees in problems involving uncertainty unless alternate lookahead search methods are developed. Worse still, standard lookahead fails when probability distribution is continuous (e.g. the processing time for machine might be normally distributed) because the number of children is infinite.

The traditional approach to model uncertainty relies on Markov Decision Processes (MDPs). An MDP consists of a tuple <S,A,p,G>:
S is a set of states that represent situations in the particular world. For example, it might represent the set of possible buffer values and the state of each machine (busy, idling, producing a certain part). Just as in chess, the state space is explicitly built through the application of actions and only that portion of the state space necessary to make a decision is enumerated. States in manufacturing encode the time and in-process actions.
A is the set of actions (decisions). An action in our manufacturing environment is to commit a particular resource to a particular task. An action can also be a vector of parallel actions, one for each resource.
p(t|a,s) is the probability of state t given action a in state s. This is the transition function that reflects the outcome of applying an action to a state. For example, it can capture that a part might be produced with a certain defect with a certain probability.
G(s) is a goal predicate that is true when a terminal state is reached. In a make-to-order manufacturing environment, G(s) is true when all orders have been fulfilled. In a make-to-stock environment, this might capture stochastic (forecasted) demand over a given time interval.
u(s) is the utility of that goal state. We plan on using profit/loss as the utility. We assume that the state encodes any profit or loss incurred along the path to the goal state—this simplifies the presentation of the objective function below.

$$f ( s ) = \{ \begin{matrix}u ( s ) & G ( s ) \\ max \{ ( {\sum }_{t ∈ S} p ( t \text{\vert} a , s ) f ( t ) ) \text{\vert} a ∈ A \} & otherwise\end{matrix}$$

Using this framework, it is possible to define an objective function:

Bellman introduced a form of this function in 1957, and others have since elaborated it in fields of Operations Research and Artificial Intelligence. According to decision theory, we want to choose that action a that maximizes

$${\sum }_{t ∈ S} p ( t \text{\vert} a , s ) f ( t )$$

for state s. The function f(t) is computed by lookahead.

In contrast to an artificial application like chess, the complexity of real-world applications makes lookahead more challenging. Since generating and applying actions in real-world applications typically take much more time than that in a chess game, deep lookahead with branch-and-bound pruning in not practical, even without uncertainty. In other words, the problem with real-world MDPs is that they cannot be efficiently computed for deep lookahead.

Coming from a different background, U.S. Pat. No. 5,764,953 issued on Jun. 9, 1998 to Collins et. al. describes an integration of active and simulated decision making processes. However, the purpose of that integration was to reduce the cost and errors of simulation, that is, the active decision making process was used to improve the simulated decision making process. Our integration of the two processes is for the opposite purpose—simulated decision making process is used to improve the active decision making process. Because of this reversal of purpose, our integration is also technically very different from their integration.

Real-time decision-making in real-world manufacturing applications is currently dominated by dispatch rules. A dispatch rule is a fixed rule used to rapidly make processing or transfer decisions. Examples include:

Kanban: produce a part only if required by a downstream machine.

CONWIP: maintain a constant set of items in each buffer.

First-come, first-served.

Choose the shortest route to get to a destination.

Dispatch rules have several problems. First, they are myopic: they don't take into account the future impact of their decisions. Any fixed, finite rule can capture only a finite portion of the manufacturing complexity. As a result, dispatch rules are notorious for making non-optimal decisions. Second, they do not take advantage of additional decision-making time that might be possible to improve decision-making quality (say through lookahead). The traditional “control-oriented” view is that a fixed dispatch rule is determined ahead of time, programmed into a controller, and executed without further deliberation. Third, most dispatch rules do not take into account the particular target goal state—they are applied blindly.

### DISCLOSURE OF INVENTION

In view of the shortcomings of existing lookahead techniques for active decision making, this invention is directed to a new lookahead process for active decision making that integrates a simulated decision making process.

A preferred embodiment of our invention uses a new type of objective function, one that computes the expected outcome:

$$f ( s ) = \{ \begin{matrix}u ( s ) & G ( s ) \\ {\sum }_{a ∈ A} p ( a \text{\vert} s ) \{ {\sum }_{t ∈ S} p ( t \vert a , s ) f ( t ) \} & otherwise\end{matrix}$$

In this embodiment, the decisions are made according to the same rule as before: choose that action a that maximizes

$${\sum }_{t ∈ S} p ( t \text{\vert} a , s ) f ( t )$$

for state s; where f(t) is computed with the above expectation-based function rather than the Bellman-style function. Instead of the actual expected outcome, its estimate could be used by sampling some of the actions a and states s.

The function p(a|s) is called a stochastic policy, which is the probability of action a given state s. This policy guides the decision-maker by appropriately weighting the outcome of each branch during the computation of the above objective function. For example, FIG. 5 shows that the expected value is 4.75 at the root. For multiple decision-making agents, this function defines a stochastic coordination policy, which describes how all agents are likely to behave.

We have developed a sampling apparatus to compute this function efficiently. This apparatus is based on the Monte Carlo principle of simulation: produce samples according to the underlying probability distribution: in our case, to repeatedly sample paths to terminals where each choice point is chosen according randomly from the distribution defined by p(a|s) and p(t|a,s); return the average value over multiple samples. Clearly, this sampling apparatus will compute the above expectation-based function as the number of samples gets large.

This sampling approach has several advantages. First and most important it focuses the search only on those portions of the lookahead tree that are likely to occur. This makes it computationally efficient Second, it can be used to make real-time decisions where deliberation time can be traded against accuracy: the more samples the more accurate the result in terms of difference with the expectation-based function. Finally, it can be sped up by parallelism: multiple machines can compute different samples in parallel.

The major advantage of the expectation-based approach is that an agent can take into account how the other agents are likely to behave rather than how they optimally behave. For example, in computer chess, the usual assumption is that the opponent will play optimally against us. This assumption makes chess programs play conservatively because they assume a perfect opponent It might be possible to improve performance if we played to the opponent's likely moves rather than optimal moves.

In general, the stochastic policy becomes an integral part of the simulation decision making model of the application. Each run of this simulation model generates a new branch of the lookahead tree.

Our approach has several advantages over dispatch rules. First, it is situation specific. It is computationally simpler to make a decision for a specific state and target production goal through lookahead than it is to learn a general dispatch rule for all states and all goals. This is because lookahead only elaborates that portion of the lookahead tree necessary to make an immediate decision. Producing a full schedule of future events is much more expensive. Second, it is not necessary to build a separate simulation model or to halt production in order to test the lookahead-based approach. The lookahead model itself functions as a simulator—a smart one that includes future decisions. Third, it is possible to learn the parameters of the model from factory-floor data, thus reducing the cost of deploying our system Finally, our approach scales with parallelism: we can distribute the decision making to multiple agents, each representing a resource.

Additional features and advantages of the invention will be set forth in part in the description that follows, and in part will be apparent from the description, or may be learned by practice of the invention. The advantages of the invention will be realized and attained by the system particularly pointed out in the written description and claims hereof, as well as in the accompanying drawings. It is to be understood that both the foregoing general description and the following detailed description are exemplary and explanatory only, and not restrictive of the invention, as claimed.

The accompanying drawings are included to provide a further understanding of the invention and are incorporated in and constitute a part of this specification. The drawings illustrate exemplary embodiments of the invention and together with the description serve to explain the principles of the invention.

### BRIEF DESCRIPTION OF DRAWINGS

FIG. 1 shows a portion of the lookahead tree built for chess. Nodes in this tree represent states or situations of the chessboard; directed arcs represent moves that result in a new state. The arcs emanating from the root node represent the first player's move possibilities; the ones from the level below that, the second player's move possibilities; alternate layers represent the alternating moves between the two players. If moving the queen is guaranteed to lead to a winning outcome and the rest of the moves are not, then that is the move of choice.

FIG. 2 shows how branch-and-bound pruning works when no uncertainty is present. A node can be pruned as long as it can be proved not to affect the value of an ancestor. In this case, the lower-bound property of the heuristic is used to prune the node.

FIG. 3 shows that branch-and-bound pruning fails when uncertainty is present. The reason is that the pruning bound grows exponentially with each level of uncertainty.

FIG. 4 shows how the expected value is computed at the root

FIG. 5 shows our system architecture for decision-making on the factory-floor. The factory model, which consists of a model of the effects of each action and their likelihood, is used by a set of decision-making agents to make a decision. This decision takes effect on the factory floor and the results of this decision are analyzed by the learning system, which in turn modifies the parameters of the factory model. The figure also shows interfaces to the factory floor environment, which consists of database information about inventory, resource availability, calendars, suppliers, shift information and customer orders. Such functions are typically handled by vendors from MRP, ERP, Supply-Chain Management, and Order Management

FIG. 6 shows a flexible manufacturing system.

FIG. 7 shows how each agent makes a decision for a particular state. Each agent generates a list of possible actions for itself. It then samples the other possible actions of other agents according to the stochastic policy p(a|s). For each of these samples, it computes the lookahead. Next, each agent chooses that action that is associated with the lowest average outcome (where average is derived from the aforementioned sampling process). Finally, each agent applies the action. The resulting state becomes the new state and the cycle continues.

FIG. 8 describes the lookahead method. If the state is a terminal then the terminal's value is returned. This value represents the utility for that state. For example, the utility might include the path cost plus a heuristic estimate. Or, it might be path cost, plus the final outcome value. If a terminal is not reached, then the set of actions is sampled according to p(a|s), across all decision-makers and the resulting action set is applied by computing the next state. From this step, the loop continues to the first step (the terminal check).

FIG. 9 shows an example of a knowledge representation structure for the stochastic policy. The particular structure is that of a Bayesian Network In principle, other structures such as neural nets or decision trees could be used to represent that policy.

FIG. 10 shows that the lookahead model can be used as a simulator that interleaves decision-making with simulation.

FIG. 11 shows the interfaces of Oasys, an application of this invention.

FIG. 12 shows the interleaving of execution and lookahead modes in Oasys.

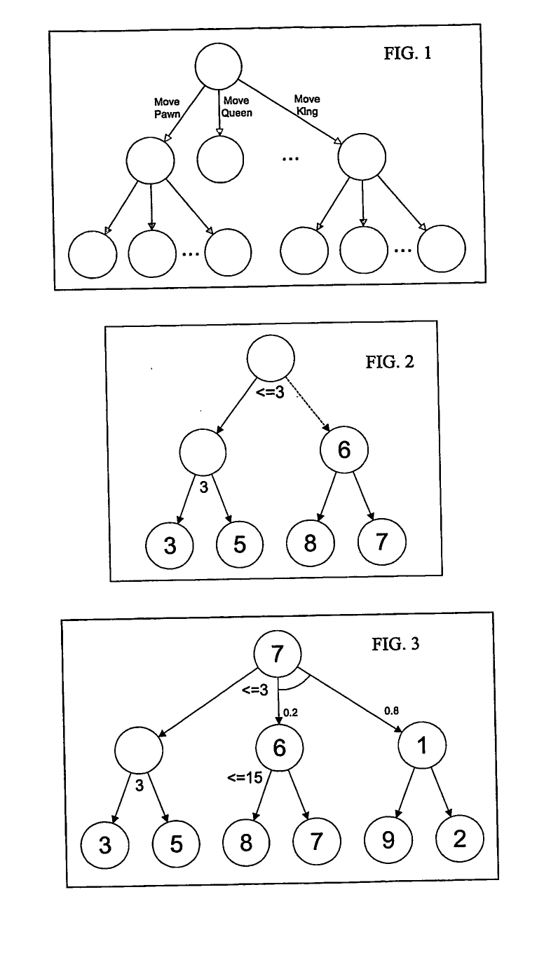

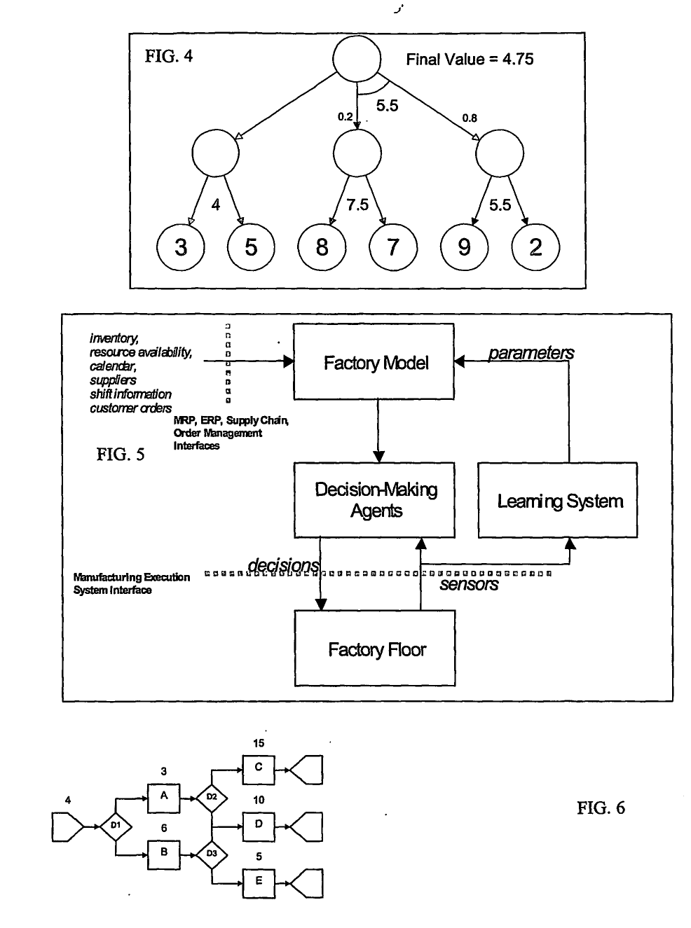

### BEST MODE FOR CARRYING OUT THE INVENTION

We will now detail an exemplary embodiment, called Simulation-Based Real-Time Decision-Making (SRDM), of the invention. One skilled in the art, given the description herein, will recognize the utility of the system of the present invention in a variety of contexts in which decision making problems exist. For example, it is conceivable that the system of the present invention may be adapted to decision making domains existent in organizations engaged in activities such as telecommunications, power generation, traffic management, medical resource management, transportation dispatching, emergency services dispatching, inventory management, logistics, and others. However, for ease of description, as well as for purposes of illustration, the present invention primarily will be described in the context of a factory environment with manufacturing activities.

FIG. 5 shows our system architecture for real-time factory-floor decision-making. The Factory Model consists of information such as the structure of the factory, how each action affects the state of the factory, how often resources fail, and how often are parts defective. This information is used by the Decision-Making Agents for lookahead and decision-making. These agents make a decision independently and in parallel that takes effect on the Factory Floor. The Factory Floor responds with updates to the state which is sensed through the sensors. This information is then fed through the Learning System, which in turn, updates the Factory Model. This cycle continuous indefinitely.

For a specific illustration, consider the routing problem in a simple reliable flexible (one-part with multiple routings) manufacturing system as shown in FIG. 6. This system consists of 5 machines (A to E) arranged in two layers and connected by various route segments. Identical parts arriving from the left side are completely processed when they depart at the right side, after following any of the following alternative routes: A-C, A-D, B-D, or B-E. Thus, there are three decision opportunities:

1. New part: choose either Machine A or B.

2. After Machine A: choose either Machine C or D.

3. After Machine B: choose either Machine D or E.

Thus, the decision alternatives are Left (A, C, and D, respectively, for the three decisions) or Right (, D, and E, respectively). The route segments as well as the queues in front of each machine are FIFO (first-in-first-out). The operational objective (KPI) is to minimize the average lead time, that is, the average time a part spends in the system (from arrival to departure). In this illustration, the arrival and processing times are exponentially distributed—FIG. 6 also shows the corresponding means (in Minutes). The travel time between each pair of nodes is fixed to 2 Minutes.

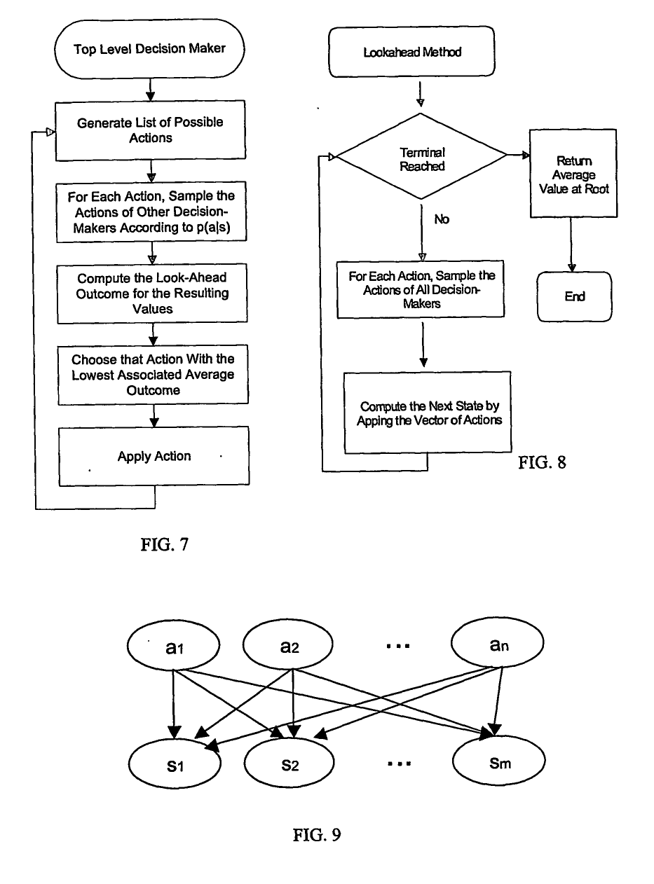

In SRDM, the top-level decision maker uses the steps given in FIG. 7 to make and apply decisions. In a state (or situation) s, it first generates a list A of possible actions (or decisions or alternatives). For each action in A, it samples the actions of other decision makers based on the stochastic policy p(a|s) (our invention covers the special case of uniform stochastic function, where all p(a|s) have identical values for any given state). For each such sample, it computes the lookahead outcome using the steps given in FIG. 8. It then chooses and applies the action with the lowest associated outcome.

To compute the lookahead outcome (see steps in FIG. 8), the decision maker keeps on applying the simulated actions of all decision makers (including itself) and sampling new actions until the lookahead depth (terminal) is reached. It repeats this several times and returns, as outcome, the average of the utility of all the terminals. The utility is the sum of the utility observed until reaching the terminal and the heuristics value of the terminal.

SRDM relies on a discrete event simulation model of the underlying application. Though the simulation uses a fixed policy (deterministic or stochastic, manual or optimized), SRDM does not use that policy to make a decision in the current situation. Instead it runs several simulations (called look-aheads) for a small number of alternative decisions and then selects the decision that optimizes the Key Performance Indicators (KPIs). In short, the look-ahead simulations overcome the myopia and rigidity of the underlying fixed policy by taking into account the longer-term impact of each decision in the current situation. Each look-ahead simulation is used to compute the KPIs by combining the KPIs observed during the look-ahead and the KPIs estimated from the terminal situation in that look-ahead.

SRDM is defined by four key parameters:
1. Policy: Which fixed policy to use during the look-ahead simulations?
2. Depth: How long to run each look-ahead simulation?
3. Width: How many look-ahead simulations to run for each decision alternative?
4. Heuristics: Which heuristics to use to estimate the KPIs at the end of each look-ahead simulation? Heuristics are necessary to estimate the KPIs for the work in progress.

For each decision opportunity, SRDM uses the simulation model to generate the required number of depth-restricted look-ahead simulations for each alternative. The KPIs from these look-aheads are averaged and the decision with the best aggregated KPI is chosen.

The real-time constraint is met as follows: SRDM starts with depth 0, where the fixed policy completely determines the decision SRDM keeps incrementing the depth until the available time runs out or the depth limit is reached. Finally, it chooses the decision based on the last depth for which all the look-aheads were successfully completed. A more sophisticated version of SRDM interleaves both the depth and width increments to provide decisions with a desired statistical confidence level.

Typical examples of fixed policies for this case are:
Deterministic Policy: Choose the machine with the shortest queue (break ties by choosing the machine on the Right).
Stochastic Policy: The probability of choosing a machine is inversely proportional to its queue length.
Deterministic local linear: At D1, choose left if the expression “xQ(A)+yQ(B)+z” is greater than 50, where Q(M) is the length of the queue for a machine M and x,y,z are the optimized using an offline procedure like OptQuest, a commercial simulation optimization software.

We now describe SRDM's method to learn the stochastic policy from actual decision-making experience using the Maximum Likelihood (ML) principle as the learning framework. SRDM learns the parameters associated with the function p(a|s). For example, we may want to learn the probability of a resource committing to a particular task, given the state information in each buffer and what other tasks are currently executing. According to ML, we choose those parameters θ that maximize the likelihood of the data over. In our case, the data is a set of past situations (states) and the actions of each resource for those states. When the data is iid (independently and identically distributed), this simplifies the ML task to choosing θ such that

$${\prod }_{j = 1}^{r} p ( {a}_{j} \text{\vert} {s}_{j} ; θ )$$

is maximized (j is the data item number, r is the number of data items):

In particular, the function p(a|s) is represented as a Bayesian Network and the ML task simplifies to updating the parameters the BN's conditional. In essence, the updates to the parameters are updates to frequencies of certain events in the data.

For example, the BN, whose schema is shown in FIG. 9, could represent the stochastic policy. Here, the aᵢ's represent individual resources and the sᵢ's represent attributes of the state (e.g. number of objects in each buffer and what tasks are currently running). The assumption here is that all resources are probabilistically independent:

$$p ( {a}_{1} , {a}_{2} , … , {a}_{n} \text{\vert} {s}_{1} , {s}_{2} , … , {s}_{m} ) = {\prod }_{i = 1}^{n} p ( {a}_{i} \text{\vert} {s}_{1} , {s}_{2} , … , {s}_{m} )$$

According to the structure defined in the BN above:

$$p ( a \text{\vert} {s}_{1} , {s}_{2} … , {s}_{n} ) = \frac{p ( {s}_{1} , {s}_{2} … , {s}_{n} \text{\vert} a ) p ( a )}{{\sum }_{a ∈ A} p ( {s}_{1} , {s}_{2} … , {s}_{n} \text{\vert} a ) p ( a )}$$

Also according the BN above, all of the state attributes are independent:

$$p ( {s}_{1} , {s}_{2} , … , {s}_{n} \text{\vert} a ) = {\prod }_{i = 1}^{m} p ( {s}_{i} \text{\vert} a )$$

Thus, the ML task simplifies to recording the probability of each state attribute value given each resource action (i.e. which task each resource commits to); the data comes from actual decisions. For discrete-valued state attributes, this amounts to storing the frequency of the attribute value given the resource action. For continuous-valued state attributes, we use a normal distribution for which we compute the sample mean and variance, given each resource action. For continuous-valued conditional attributes (e.g. one continuous-valued state attribute conditional on another), we use a conditional multivariate normal distribution. In this distribution, a child node (indexed by 1) is normally distributed with mean μ₁+V₁₂V₂₂⁻¹(x₂−μ₂) and variance V₁₁−V₁₂V₂₂⁻¹V₂₁, where μ and V are partitioned comformably as (all the parents are indexed by 2):

$$μ = [ \begin{matrix}{μ}_{1} \\ {μ}_{2}\end{matrix} ] and V = [ \begin{matrix}{V}_{11} & {V}_{12} \\ {V}_{21} & {V}_{22}\end{matrix} ]$$

The sample mean vector and co-variance matrix are easily computed from the data.

Of course, the stochastic policy need not be represented by a Bayesian Network. Other methods such as neural networks, polynomial functions, or decision trees could be used.

Whatever method is used, the learning approach has several advantages. First, it reduces the cost of model building as the same approach can be used to learn the transition-function p(t|a,s) from data. Second, it reduces the cost of model validation since the ML principle is probabilistically sound and thus self-validating. Third, the lookahead model itself can act as a “smart” simulator—one that takes into account decisions by each agent, obviating the development of a separate simulation model for testing. Decision-making can be rigorously evaluated without disrupting the actual application. Fourth, the independence assumption makes sampling easy to compute: we need only compute p(s|a) for the current state and for each possible resource action; from this we can compute p(a|s) for each possible action and sample from a according to p(a|s). The steps from p(s|a) to p(a|s) are defined in the above equations.

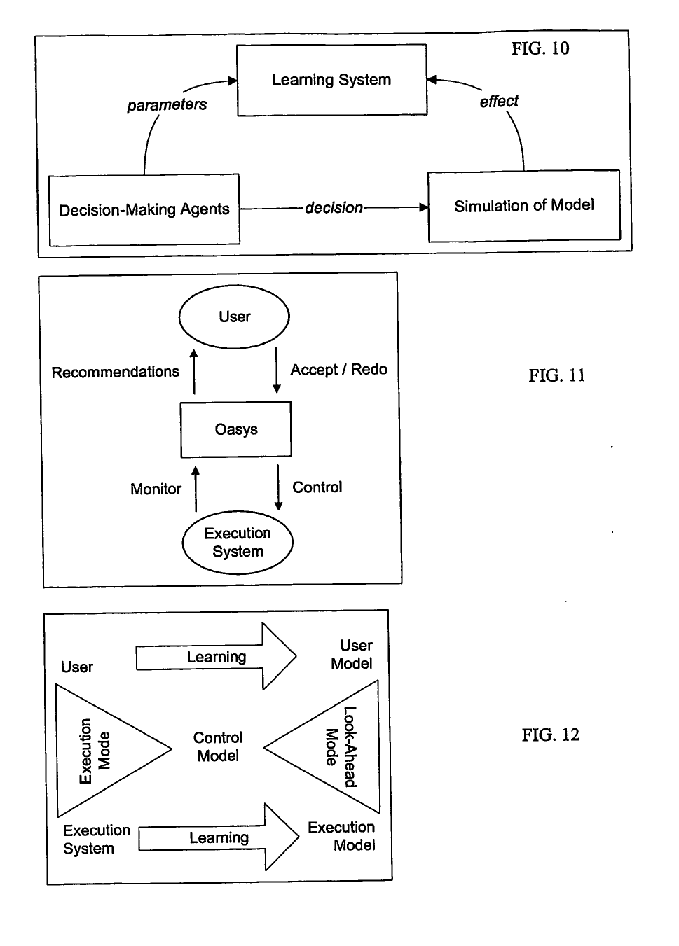

Finally, all learning can be done prior to deployment since the lookahead-simulator can generate its own training data. As FIG. 10 shows, the decision-maker (a resource) generates a decision and the model simulates that decision and all the other decisions of other decision-makers up to the next decision-point. The effect of those decisions is then input into the learning system, which in turn generates new parameters for the decision-maker.

As our decision-making engine is domain-independent and highly modular, it has the potential to be applied to other complex decision-making tasks such as network routing, medical decision-making, transportation routing, political decision-making, investment planning and military planning. It can also be applied to multiple agents—where parallel action sets a are assumed to be input. Finally, it can be applied in a real-time setting: rather than searching to terminals, it is possible to search to a fixed depth and return a heuristic estimate of the remaining utility instead. The depth begins at 0 and as long as there is decision-making time, the depth is incremented by 1. The action of choice is the best (i.e. lowest utility) action associated with the last completed depth.

Integration with a Simulation System

In another embodiment, this invention enhances an existing simulation system. Although we illustrate this by enhancing a specific simulation engine SLX; similar approach will work for other simulation systems. SLX is general purpose software for developing discrete event simulations. SLX provides an essential set of simulation mechanisms like event scheduling, generalized wait-until, random variable generation, and statistics collection. SLX also provides basic building blocks, such as queues and facilities, for modeling a wide variety of systems at varying levels of detail. SLX provides no built-in functionality for real-time synchronization or decision-making. Our enhancement, Oasys for SLX, enhances SLX in the following ways:

The user defines a specific performance measures for optimization. Performance measures include operational measures like throughput and cycle time as well as financial measures like profit and market share.

The user does not have to assign a fixed policy for each decision point. Instead, Oasys automatically chooses the decision such that the performance measure is optimized. Oasys relaxes the optimization requirement by considering other constraints such as time. For example, give me the best answer possible within 20 seconds.
Oasys enhances process specifications by allowing non-deterministic actions—these contentions are also resolved during simulation such that the performance measure is optimized.
Oasys continually learns so as to keep improving the optimisation over time.
Oasys communicates and synchronizes with external real-time monitoring and control systems.
Oasys communicates and synchronizes with users in real-time.

As shown in FIG. 11, Oasys interacts with the following external systems:
Controllers: Systems for controlling the execution systems. These systems actually effect the chosen decision in the real world.
Monitors: Systems for providing feedback from the execution systems. These systems sense the actual change in the real world. Sensors are needed because an external event may have taken place in the world or the actions might not have had their intended effect

In addition, it provides a front-end to the users for providing real-time instructions.

Oasys consists of three simulation models:
User model: for simulating users actions
Execution model: for simulating the actions of execution systems
Control model: for simulating the real-time decisions

The control model interacts with both the user and the execution model.

At any decision point in the control model, Oasys uses SLX to perform a look-ahead with a finite number of alternatives. Each look-ahead involves running one or more simulations for some period of time, determining the performance values at the end of each of those simulations, and combining those values to obtain one set of performance values. Oasys then chooses the best alternative that may get communicated to the user. The user may choose to accept or override this recommendation—the final decision may then get communicated to the external control systems.

Thus, Oasys alternates between the following two modes, as shown in FIG. 12:
Execution mode: Oasys interacts with external execution systems and users.
Look-ahead mode: Instead of interacting with external execution systems and users, the control model interacts with execution and user models, respectively.

At each decision point, after the look-ahead, Oasys presents its recommendation to the user along with the expected performance values of all the alternatives. The user must take one of the following actions:
Select the recommendation: Oasys complies with that decision and continues until the next set of recommendations.
Select an alternative: Oasys complies with that decision and continues until the next set of recommendations.
Forgo selection: Oasys will wait for a specified amount of time, and then select its recommended decision by default

Each decision selected by the user is immediately communicated to the execution system. Each observation made by the execution system is immediately communicated to Oasys, which relays it to SLX.

The decision points are defined by portions of the simulation where multiple outcomes are under our control. The execution-relevant state is explicitly saved before lookahead and restored whenever needed.

The nodes of the look-ahead tree represent portions of the simulation that are deterministic. The children of a node represent the result of alternative events. Each node is processed (possibly several times) in one of the following ways:
Terminal node: The performance forecast for the node and the performance heuristic are combined to produce the performance forecast for the decision.
A new child is generated: If this is the first node, a new child is generated according to the next decision we wish to try, otherwise a child is generated according to a probability distribution and processing passes to the child.

Thus, the following could be specified by the designer:
What are the terminal nodes?
How are children generated? E.g. probabilistic sampling.
How are performance measures combined? E.g. average, weighted by probabilities. This requires more details on the consequences of the event of going from parent to child.

The following are learned, indexed by the relevant parts of the state:
User model: To anticipate the effects of users' actions.
Execution system model: To anticipate the effects of observations made by the execution system.
Performance forecast: To predict the performance measure when a new node is encountered (before any look-ahead for that node).
   Other Exemplary Embodiments

Instead of choosing the action with the lowest average outcome given any state s, an alternative embodiment of our invention uses the following approach, where MIN-D and INC-D and MAX-D are depth parameters (positive numbers), MIN-C and INC-C are confidence parameters (numbers between 0 and 100), and MIN-N and INC-N (positive numbers) are iteration limits:

1. Set the lookahead depth D to MIN-D, the confidence level C to MIN-C and the no of samples N to MIN-N

2. Set a to be the result of LookAhead (s, D, C, N)

3. Present a to the decision maker and get the next command

4. If next command is “increase confidence” increment C by INC-C and go to step 2

5. If next command is “increase depth” increment D by INC-D and go to step 2

6. If next command is “increase iterations”, increment N by INC-N and go to step 2

7. If next command is “commit action”, stop

The function LookAhead(s, D, C, N) is calculated by the following steps, where U(a) define the distribution U1(a), U2(a) . . . , Un(a) for each action a with mean S(a) and standard deviation D(a) and let M(a) be the actual mean being estimated by the sample mean S(a):

1. Set n=1

2. For each alternative action a in state s, perform lookahead to get utility Un(a)

3. Partition the actions into two categories, a non empty Indifference set I and Reject set R, such that

a. For any two actions a in I and b in R, the confidence that M(a)>M(b) is more than C.

b. For any two actions a and b in I, the confidence level that M(a)>M(b) is at most C.

4. If R is empty and n<N, increment n by 1 and go to step 2

5. Return any action from the set I

If the number of possible actions in a state is large or infinite, only a few of the most probable action are considered, by sampling them using the stochastic policy P(a|s) at state s. The cutoff could be specified in several ways, for example, setting a limit on number of distinct actions.

There is an alternative way to define the sets I, by using another confidence parameter B, no larger than C. This parameter B can also be varied based on the next command, just like the parameter B.

Another approach is to use a stochastic policy to generate the initial probabilities for various alternatives of a decision, and then use look-ahead to refine these probabilities, until some termination criterion is satisfied.

In general, the look-ahead strategy can be specified using the following:

1. Alternative generation, prioritization, and elimination.

2. Sampling sequence

3. Sample generation

4. Sample termination

5. Terminal heuristics computation

6. Sample KPI computation

7. KPI aggregation

8. Look-ahead termination

9. Alternative Selection

Instead of using a standard execution model simulator for the lookahead, a faster abstract model may be used. This model, implemented in a general purpose programming language like C++, may be learned using observations made on the real execution system or its simulator.

If there are multiple concurrent decisions to be made, one could construct a dependency graph among them, based on whether a decision impacts another. Except for the cycles in this graph, the rest of the decisions may be then serialized. For multiple inter-dependent decisions, several approaches may be used:

1. Treat them as one complex decision (alternatives multiply)

2. Approximate them by a sequence of decisions (alternatives add up)

3. Intermediate approaches (may be based on standard optimization approaches like local search, beam search, evolutionary algorithms, etc.)

More Complex Belief Networks

Instead of using a simple belief network, alternative embodiments of our invention use more complex belief networks, including

1. Hierarchical variables in belief networks

2. Belief networks with abstract data types:

3. Belief networks with user-defined parameterized (re-usable) functions.

4. Higher-order Belief networks models with differentials

5. POMDPs (Partially Observable MDP) where the belief-vector distribution is represented by a Belief network itself, which is updated through the application of decisions and observations.

We detail these alternative embodiments below.

1. Belief Networks with Hierarchical Variables

An important method of dealing with complexity is to place things in hierarchy. For example, the animal kingdom's taxonomy makes it easy for scientists to understand where each organism is located in that kingdom. Zip codes, which are hierarchically coded for each region, make it easier for the post office to distribute mail. The usual way of dealing with such hierarchies in a Belief Network is to use an “excess” encoding that represents non-sensical combinations as a zero probability. For example, if objects a particular universe are Male or Female and Females are additionally Pregnant or Non-Pregnant, then the usual way of encoding such a hierarchy is to represent one node in the Belief Network for Sex and another node for Pregnant (a Boolean). This method requires the user to specify a zero probability for Male and Pregnant.

In our embodiment, there is only one node, namely representing Male or Female and if Female, then Pregnant or Non-Pregnant. The values for the variable at the node are three-fold: Male, Female/Pregnant, and Female/Non-Pregnant Male and Female have their prior probabilities and Pregnant is conditional on Female. This reduces the memory requirements and makes it simpler to learn such information from data using standard leaning techniques.

This method of hierarchical variable can also be extended to clustering, where the hierarchies are given, but the parameters are not known Standard learning methods such as EM can be used to fit the hierarchies to data.

Finally, these hierarchies can be generalized to partial orders, where objects may belong to more than one parent class. The extension is relatively straightforward: a hierarchical variable can now be conditional on two or more parents, just as in standard Belief Networks.

2. Belief Networks with Abstract Data Types

Abstract data types in our embodiment include but are not limited to:
Stacks
Queues
Priority Queues
Records
Matrices
Association Lists
Count Lists
Existence tables
Sets
Bags

Programming languages have long used such data types to make it simpler for programmers to develop their applications without having to specify functions that operate on those types or the details of how those functions operate. The motivation for use in Belief Networks is similar: after specifying the type of each variable, the user can specify how such a variable changes with each decision using the built-in functions and tests that operate on those types. For example, in manufacturing, the user often requires queues to describe a factory process and the built-in type Queue makes it simple for the user to specify a queue.

3. Higher-Order Belief Networks with Differentials

Sometimes one would like to specify the effects of a decision or a policy in terms of information from previous states. The stochastic policy can be generalized to include information from previous states. For example p(a|s,t) captures the idea of that the probability of an action depends on the state s and some other previous state t, which could be a vector of previous states. Similarly, the transition function can be generalized to include information from previous states: p(w|a,s,t).

More generally, the policy and transition might depend on a differential vector of previous states rather than the states themselves. For example, the acceleration (a first-order difference), might be required for decision-making in an application for an autonomous guided vehicle.

4. Belief Networks with User-Defined Functions

To declare a function that a user can reuse, the user must specify certain information as in any modern programming language: parameters, local variables, and other functions within their scope. All of these can be referred to in the Bayes Network for the definition of a function. Once defined, functions can be re-used just as any built-in function. This is an important way for the user to extend the set of built-in functions to suit a particular application and to facilitate re-use.

The function definition involves the specification of a Belief Network possibly with multiple nodes, but with a single output node representing the result of the function. The other nodes can be a combination of parameters, local variables, or variables global in scope to that function. Each node can reference other functions or recursively reference the current function.

5. Belief Networks with POMDPs as Embodied by Belief Network Representations of the Distribution

In a POMDP, the state is represented by a belief vector that captures the probability distribution associated with a particular state. Our additional embodiment is to represent this belief vector as a Belief Network itself. This network can be made arbitrarily complex, depending on the user's specification. For example, the x, y position of a vehicle might be a multi-variate normal distribution or it might be a univariate normal distribution. Events (actions or observations) cause this Belief Network to be updated according to the underlying transition function. However, unlike in standard MDPs or standard POMDPs, observations cause a change in state just as with actions. The way this change in state takes place can include, but is not limited to: user-specified operations on the Belief Network and multiple sampling of the belief network according the transition function. In the case of sampling, the weights of the network are adjusted for each prior combination of variables, for each child-node and parent nodes. This compact representation of a belief vector makes allows the solution of POMDPs of greater complexity than before. Moreover, it generalizes approaches such as Kalman Filtering.

Having described the exemplary embodiments of the invention, additional advantages and modifications will readily occur to those skilled in the art from consideration of the specification and practice of the invention disclosed herein. Therefore, the specification and examples should be considered exemplary only, with the true scope and spirit of the invention being indicated by the enclosed claims.

1. A method for optimizing an active decision making process that requires selecting actions at a sequence of choice points, comprising:
a. creating a simulation model for the active decision making process comprising the potential effects of an action;
b. generating a plurality of alternative actions at a choice point in the active decision making process;
c. for one of these alternative actions, generating a simulation of the future decision making process using the simulation model; and
d. analyzing the result of this simulation to select an action for the choice point.

2. The method of claim 1, wherein the simulation model comprises a stochastic component.

3. The method of claim 2, wherein the stochastic component comprises a policy for choosing among alternative decisions.

4. The method of claim 1, wherein two simulations are interleaved such that one simulation starts before another ends.

5. The method of claim 1, wherein the simulation model comprises of a Bayesian network.

6. The method of claim 1, wherein the simulation model comprises a component selected from the group consisting of hierarchical variables, abstract data types, differential vector of previous states, user-defined functions, Markov decision processes, partially-observable Markov decision processes, heuristics evaluation function, user model for simulating users of the active decision making process, execution model for simulating an external application, and control model for simulating the active decision making process.

7. The method of claim 1, further integrating the active decision making process with an external application.

8. The method of claim 7, wherein the external application comprises a simulation system.

9. The method of claim 7, wherein the simulation model is updated using the data obtained by monitoring the external application.

10. The method of claim 1, wherein the simulation model is updated using the result of the simulation.

11. A computer implemented system for optimizing an active decision making process that requires selecting actions at a sequence of choice points, comprising:
a. a simulation model for the active decision making process comprising the potential effects of an action;
b. generation of a plurality of alternative actions at a choice point in the active decision making process;
c. for one of these alternative actions, generation of a simulation of the future decision making process using the simulation model; and
d. analysis of the result of this simulation to select an action for the choice point.

12. The system of claim 11, wherein the simulation model comprises a stochastic component.

13. The system of claim 12, wherein the stochastic component comprises policy for choosing among alternative decisions.

14. The system of claim 11, wherein two simulations are interleaved such that one simulation starts before another ends.

15. The system of claim 11, wherein the simulation model comprises of a Bayesian network.

16. The system of claim 11, wherein the simulation model comprises a component selected from the group consisting of hierarchical variables, abstract data types, differential vector of previous states, user-defined functions, Markov decision processes, partially-observable Markov decision processes, heuristics evaluation function, user model for simulating users of the active decision making process, execution model for simulating an external application, and control model for simulating the active decision making process.

17. The system of claim 11, further integrating the active decision making process with an external application.

18. The system of claim 17, wherein the external application comprises a simulation system.

19. The system of claim 17, wherein the simulation model is updated using the data obtained by monitoring the external application.

20. The system of claim 11, wherein the simulation model is updated using the result of the simulation.
